(19) United States
(12) Patent Application Publication
(10) Pub. No.: US 2025/0385621 A1
(43) Pub. Date: Dec. 18, 2025

(54) THREE-PHASE SINGLE-STAGE POWER SUPPLY

(71) Applicant: Delta Electronics, Inc., Taipei (TW)

(72) Inventors: Misha Kumar, Morrisville, NC (US); Peter Mantovanelli Barbosa, Morrisville, NC (US)

(21) Appl. No.: 19/237,817

(22) Filed: Jun. 13, 2025

Related U.S. Application Data
(60) Provisional application No. 63/659,558, filed on Jun. 13, 2024.

(51) Int. Cl. H02M 7/797; H02M 1/00; H02M 1/084; H02M 1/14; H02M 1/44; H02M 7/81

(52) U.S. Cl. CPC H02M 7/797; H02M 1/0009; H02M 1/084; H02M 1/143; H02M 1/44; H02M 7/81

(57) ABSTRACT

A three-phase single-stage power supply includes a positive output terminal, a negative output terminal, a first single-stage conversion module, a second single-stage conversion module, and a third single-stage conversion module. Output terminals of the first single-stage conversion module, the second single-stage conversion module and the third single-stage conversion module are connected in parallel between the positive output terminal and the negative output terminal. The third single-stage conversion module includes a third transformer, a third output rectifier circuit, a relay, an auxiliary inductor and an auxiliary capacitor. The third rectifier circuit includes a fifth switch circuit and a sixth switch circuit, which includes two switches connected in series, respectively, and the relay, the auxiliary inductor and the auxiliary capacitor are connected in series between a midpoint of the two switches in the sixth switch circuit and the negative output terminal, to be served as a buck/boost converter.

### CROSS-REFERENCE TO RELATED APPLICATION

This application claims the benefit of U.S. Provisional Application No. 63/659,558 filed on Jun. 13, 2024, and entitled “OUTPUT CURRENT AND VOLTAGE RIPPLE REDUCTION TECHNIQUES FOR SINGLE-STAGE BIDIRECTIONAL POWER SUPPLY”. The entireties of the above-mentioned patent application are incorporated herein by reference for all purposes.

### FIELD OF THE INVENTION

The present disclosure relates to the field of power supply, and more particularly to a three-phase single-stage power supply.

### BACKGROUND OF THE INVENTION

A power supply may generally convert the alternating current (AC), such as from the grid, to the direct current (DC). A power supply with two stage circuit topology may use a power factor correction (PFC) converter as the first stage to convert the AC voltage into a first DC voltage, and use a DC-DC converter as the second stage to convert the first DC voltage into the second DC voltage with desired voltage level. Generally, the power factor correction refers to making the line current follow the shape of the line voltage. A PFC converter is configured to perform the power factor correction as well as rectification of an AC input. Generally, a DC-DC converter may include a DC-AC converter, a transformer and an AC-DC converter. The DC-AC converter converts the DC voltage into the AC voltage. The transformer is configured to pass the AC signal from a primary side by electromagnetic induction to a secondary side of the transformer. The AC-DC converter on the secondary side of the transformer is configured to convert the AC voltage into a DC voltage with desired voltage level at the output terminal of the DC-DC converter. A bidirectional power supply refers to one that facilitates both AC to DC and DC to AC conversion.

Typically, a three-phase single-stage power supply with balanced three-phase input voltage has relatively small low frequency (e.g., 100 Hz or 120 Hz) output voltage and current ripple because of the 120-degree phase-shift between the two consecutive phases of the three-phase input voltage. However, in some applications, if the three-phase single-stage power supply is operated with the single-phase input source, then, the low frequency (e.g., 100 Hz or 120 Hz) output voltage and current ripple becomes significantly large which is not desirable for some loads, for example, for battery loads.

Moreover, if the three-phase single-stage power supply operates with unbalanced three-phase input voltage, the low frequency (e.g., 100 Hz or 120 Hz) output voltage and current ripple also becomes significantly large which is not desirable for some loads. This is because, in unbalanced three-phase input voltage, the three voltages have different rms values and/or the consecutive phases are not 120-degree phase-shifted. The above-mentioned situation is not desirable for some loads.

FIG. 1 is a schematic circuit diagram illustrating a conventional three-phase single-stage power supply according to the prior art. As shown in FIG. 1, the conventional three-phase single-stage power supply 1 includes a first single-stage conversion module 1a, a second single-stage conversion module 1b and a third single-stage conversion module 1c. A single-phase input voltage or a three-phase input voltage is received by the first single-stage conversion module 1a, the second single-stage conversion module 1b and the third single-stage conversion module 1c. The first single-stage conversion module 1a, the second single-stage conversion module 1b and the third single-stage conversion module 1c have similar circuit topologies. The first single-stage conversion module 1a includes a plurality of switches S₁, S₂, S₃, S₄, S₅, S₆, S₇, S₈, S₉, S₁₀, a first transformer TR₁₁ and an output capacitor Coa. The second single-stage conversion module 1b includes a plurality of switches S₁₁, S₁₂, S₁₃, S₁₄, S₁₅, S₁₆, S₁₇, S₁₈, S₁₉, S₂₀, a second transformer TR₁₂ and an output capacitor Cob. The third single-stage conversion module 1c includes a plurality of switches S₂₁, S₂₂, S₂₃, S₂₄, S₂₅, S₂₆, S₂₇, S₂₈, S₂₉, S₃₀, a third transformer TR₁₃ and an output capacitor C_{oc}. In addition, the three-phase single-stage power supply 1 further includes a first relay R₁. The first relay R₁ is electrically connected between an input terminal of the first single-stage conversion module 1a and an input terminal of the second single-stage conversion module 1b. Moreover, the third single-stage conversion module 1c further includes a second relay R₂ and a decoupling capacitor Cpd. The second relay R₂ and the decoupling capacitor C_{pd} are electrically connected to a secondary side of a transformer TR₁₃ in the third single-stage conversion module 1c.

When the three-phase single-stage power supply 1 operates with the single-phase input voltage, the first relay R₁ and the second relay R₂ are turned on, and the switches S₂₇, S₂₈, S₂₉, S₃₀ disposed at the secondary side of the transformer TR₁₃ in the third single-stage conversion module 1c, the decoupling capacitor C_{pd} and the transformer TR₁₃ form a buck/boost converter. The buck/boost converter controls the output current i_{oc} of the third single-stage conversion module 1c to be of the opposite phase to the sum of the output current iₒₐ of the first single-stage conversion module 1a and the output current job of the second single-stage conversion module 1b. It results in relatively small ripple in the output current i_{B}. When the ripple of the output current i_{B} is greater than zero, the duty cycle of the switches at the secondary side of the third single-stage conversion module 1c is modulated so that the third single-stage conversion module 1c operates as a buck converter to transfer power from the total equivalent capacitor formed by parallel connection of output capacitors Cₒₐ, C_{ob}, and C_{oc} to the decoupling capacitor C_{pd}. However, when the ripple of the output current i_{B} is smaller than zero, the duty cycle of the switches at the secondary side of the third single-stage conversion module 1c is modulated so that the third single-stage conversion module 1c operates as a boost converter to transfer power from capacitor C_{pd} to the total equivalent capacitor formed by parallel connection of output capacitors Cₒₐ, C_{ob}, and C_{oc}. In this way, the low frequency output current ripple is reduced when the three-phase single-stage power supply 1 is operated with the single-phase input voltage.

FIG. 2 is a schematic circuit diagram illustrating another conventional three-phase single-stage bidirectional power supply based on LLC resonant converter according to the prior art. As shown in FIG. 2, the conventional three-phase single-stage power supply 2 includes a first single-stage conversion module 2a, a second single-stage conversion module 2b and a third single-stage conversion module 2c. The first single-stage conversion module 2a, the second single-stage conversion module 2b and the third single-stage conversion module 2c have similar circuit topologies. The first single-stage conversion module 2a includes an EMI filter, a plurality of switches S_{I11}, S_{I21}, S_{I31}, S_{I41}, S_{P11}, S_{P21}, S_{P31}, S_{P41}, S_{S11}, S_{S21}, S_{S31}, S_{S41}, a transformer TR₁₁ and an output capacitor. The second single-stage conversion module 2b includes an EMI filter, a plurality of switches S_{I12}, S_{I22}, S_{I32}, S_{I42}, S_{P12}, S_{P22}, S_{P32}, S_{P42}, S_{S12}, S_{S22}, S_{S32}, S_{S42}, a transformer TR₁₂ and an output capacitor. The third single-stage conversion module 2c includes an EMI filter, a plurality of switches S₁₁₃, S₁₂₃, S₁₃₃, S₁₄₃, S_{P13}, S_{P23}, S_{P33}, S_{P43}, S_{S13}, S_{S23}, S_{S33}. S_{S43}, a transformer TR₁₃ and an output capacitor. If the three-phase single-stage bidirectional power supply 2 of FIG. 2 operates with balanced three-phase input voltage, the output voltage and current will have relatively small low-frequency peak-peak ripple. However, if three-phase single-stage bidirectional power supply 2 of FIG. 2 operates with single-phase input voltage or with unbalanced three-phase input voltage, the output voltage and current will have relatively large low-frequency peak-peak ripple, which is not desirable for certain types of loads, for example, for battery loads.

Therefore, there is a need of providing a three-phase single-stage power supply to obviate the drawbacks encountered by the prior arts.

### SUMMARY OF THE INVENTION

An object of the present disclosure is to provide a three-phase single-stage power supply to address the issues caused by the conventional three-phase single-stage power supply, in which if the three-phase single-stage power supply is operated with the single-phase input voltage or an unbalanced three-phase input voltage, the low frequency (e.g., 100 Hz or 120 Hz) output voltage and current ripple becomes significantly large which is not desirable for some loads.

In accordance with an aspect of the present disclosure, a three-phase single-stage power supply is provided and includes a positive output terminal, a negative output terminal, a first single-stage conversion module, a second single-stage conversion module and a third single-stage conversion module. An output terminal of the first single-stage conversion module, an output terminal of the second single-stage conversion module and an output terminal of the third single-stage conversion module are connected in parallel between the positive output terminal and the negative output terminal. The third single-stage conversion module includes a third transformer, a third output rectifier circuit, a relay, an auxiliary inductor and an auxiliary capacitor, wherein the third output rectifier circuit includes a fifth switch circuit and a sixth switch circuit, the fifth switch circuit and the sixth switch circuit includes two switches connected in series, respectively, and the relay, the auxiliary inductor and the auxiliary capacitor are connected in series between a midpoint of the two switches of the sixth switch circuit and the negative output terminal, so that the third single-stage conversion module is served as a buck/boost converter.

In accordance with another aspect of the present disclosure, a three-phase single-stage power supply is provided and includes a positive output terminal, a negative output terminal, a first single-stage conversion module, a second single-stage conversion module and a third single-stage conversion module. An output terminal of the first single-stage conversion module, an output terminal of the second single-stage conversion module and an output terminal of the third single-stage conversion module are connected in parallel between the positive output terminal and the negative output terminal. The third single-stage conversion module includes an input rectifier circuit, a third inverter circuit, a third LLC resonant circuit, a DC blocking capacitor, a resonant capacitor, a third transformer, a third output rectifier circuit, a first relay, a first auxiliary capacitor, a second relay and a second auxiliary capacitor. The third output rectifier circuit includes a fifth switch circuit and a sixth switch circuit, the fifth switch circuit and the sixth switch circuit includes two switches connected in series, respectively, the DC blocking capacitor is electrically connected between a secondary winding of the third transformer and a midpoint of the two switches of the fifth switch circuit, a resonant capacitor of the third LLC resonant circuit is electrically connected between the third inverter circuit and a primary winding of the third transformer, the first relay is connected in series with the first auxiliary capacitor and then connected in parallel with the resonant capacitor, and the second relay is connected in series with the second auxiliary capacitor and then connected in parallel with the DC blocking capacitor, so that the third single-stage conversion module is served as a buck/boost converter.

In accordance with a further aspect of the present disclosure, a three-phase single-stage power supply is provided and includes a positive output terminal, a negative output terminal, a first single-stage conversion module, a second single-stage conversion module and a third single-stage conversion module. An output terminal of the first single-stage conversion module, an output terminal of the second single-stage conversion module and an output terminal of the third single-stage conversion module are connected in parallel between the positive output terminal and the negative output terminal. The third single-stage conversion module includes an input rectifier circuit, a third input filter circuit, a third LLC resonant circuit, a first relay and an auxiliary capacitor, wherein the first relay and the auxiliary capacitor are connected in series and then connected in parallel with the third input filter circuit.

### BRIEF DESCRIPTION OF THE DRAWINGS

FIG. 1 is a schematic circuit diagram illustrating a conventional three-phase single-stage power supply according to the prior art;

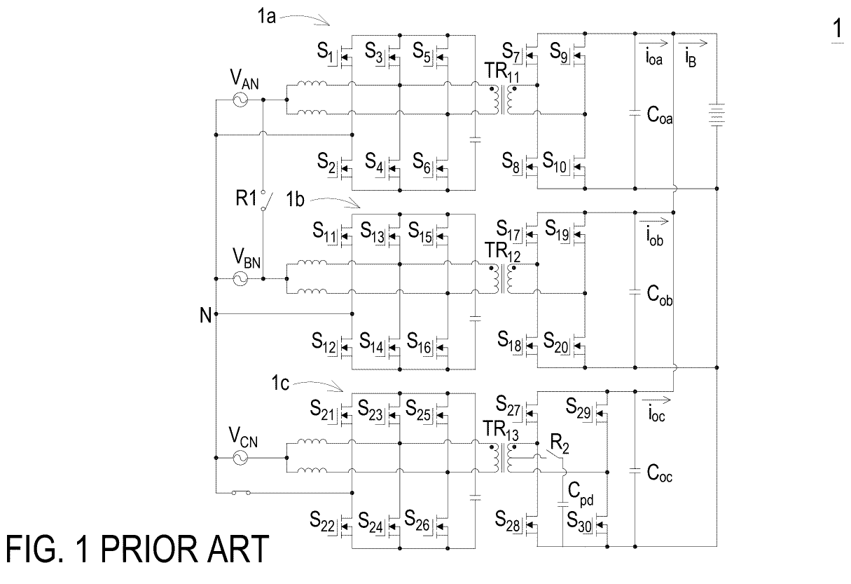

FIG. 2 is a schematic circuit diagram illustrating another conventional three-phase single-stage bidirectional power supply based on LLC resonant converter according to the prior art;

FIG. 3A is a schematic circuit diagram illustrating a three-phase single-stage power supply according to a first embodiment of the present disclosure;

FIG. 3B is a control block diagram of the third single-stage conversion module in the three-phase single-stage power supply of FIG. 3A;

FIG. 4 is a schematic circuit diagram illustrating a three-phase single-stage power supply according to a second embodiment of the present disclosure;

FIG. 5A is a schematic circuit diagram illustrating a three-phase single-stage power supply according to a third embodiment of the present disclosure;

FIG. 5B is a control block diagram of the third single-stage conversion module in the three-phase single-stage power supply of FIG. 5A;

FIG. 5C is a schematic diagram illustrating the steps of the control method of the third single-stage conversion module of the three-phase single-stage power supply shown in FIG. 5A;

FIG. 6 is a partial control block diagram of the third single-stage conversion module of the three-phase single-stage power supply shown in FIG. 2 when the three-phase single-stage power supply is operated with an unbalanced three-phase input voltage; and

FIG. 7 is a key simulation waveform illustrating the three-phase single-stage power supply shown in FIG. 2.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

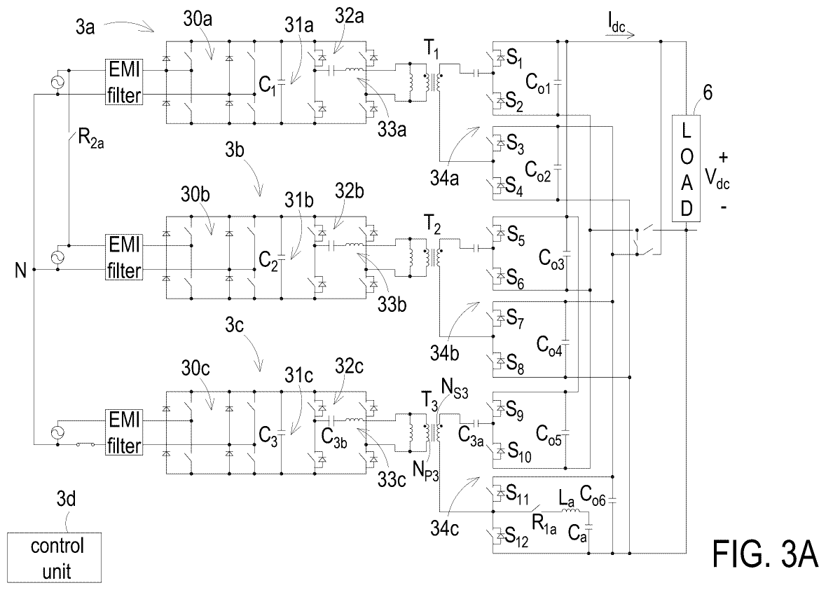

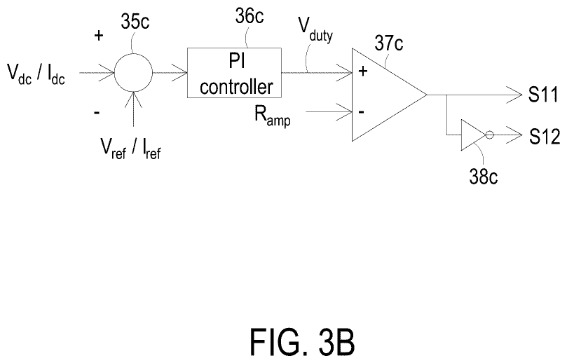

FIG. 3A is a schematic circuit diagram illustrating a three-phase single-stage power supply according to a first embodiment of the present disclosure. As shown in FIG. 3A, in the embodiment, the three-phase single-stage power supply 3 is based on the LLC resonant conversion circuit topology and has a bidirectional power conversion function. In addition, when the three-phase single-stage power supply 3 receives a single-phase input voltage to operate or receives an unbalanced three-phase input voltage, the three-phase single-stage power supply 3 can further compensate for the ripple of the output current/output voltage of the three-phase single-stage power supply 3. The three-phase single-stage power supply 3 includes a positive output terminal, a negative output terminal and three single-stage conversion modules, namely the first single-stage conversion module 3a, the second single-stage conversion module 3b and the third single-stage conversion module 3c. The positive output terminal and the negative output terminal of the three-phase single-stage power supply 3 are electrically connected to the load 6. The output terminals of the first single-stage conversion module 3a, the second single-stage conversion module 3b and the third single-stage conversion module 3c are connected in parallel between the positive output terminal and the negative output terminal. The input terminals of the first single-stage conversion module 3a, the second single-stage conversion module 3b and the third single-stage conversion module 3c are connected in parallel.

The first single-stage conversion module 3a, the second single-stage conversion module 3b and the third single-stage conversion module 3c have similar circuit topologies. In the embodiment, the first single-stage conversion module 3a includes a first input rectifier circuit 30a, a first input filter circuit 31a, a first inverter circuit 32a, a first LLC resonance circuit 33a, a first transformer T₁ and a first output rectifier circuit 34a. The second single-stage conversion module 3b includes a second input rectifier circuit 30b, a second input filter circuit 31b, a second inverter circuit 32b, a second LLC resonant circuit 33b, a second transformer T₂ and a second output rectifier circuit 34b. The third single-stage conversion module 3c includes a third input rectifier circuit 30c, a third input filter circuit 31c, a third inverter circuit 32c, a third LLC resonance circuit 33c, a third transformer T₃ and a third output rectifier circuit 34c. In some embodiments, each of the first single-stage conversion module 3a, the second single-stage conversion module 3b and the third single-stage conversion module 3c includes an EMI filter. The EMI filter of the first single-stage conversion module 3a is connected between the input terminals of the first single-stage conversion module 3a and the first input rectifier circuit 30a. The EMI filter of the second single-stage conversion module 3b is connected between the input terminals of the second single-stage conversion module 3b and the second input rectifier circuit 30b. The EMI filter of the third single-stage conversion module 3c is connected between the input terminals of the third single-stage conversion module 3c and the third input rectifier circuit 30c.

The first input rectifier circuit 30a, the second input rectifier circuit 30b and the third input rectifier circuit 30c are configured to convert the AC input into rectified AC voltage. The first input filter circuit 31a, the second input filter circuit 31b and the third input filter circuit 31c are electrically connected to the first input rectifier circuit 30a, the second input rectifier circuit 30b and the third input rectifier circuit 30c respectively, and are configured to perform filtering of the rectified AC voltage for suppressing high-frequency switching noise. The first inverter circuit 32a, the second inverter circuit 32b and the third inverter circuit 32c are electrically connected to the first input filter circuit 31a, the second input filter circuit 31b and the third input filter circuit 31c respectively, and configured to convert the rectified AC voltage into the high frequency AC voltage. The first LLC resonant circuit 33a is electrically connected between the first inverter circuit 32a and the primary winding of the first transformer T₁, the second LLC resonant circuit 33b is electrically connected between the second inverter circuit 32b and the primary winding of the second transformer T₂, and the third LLC resonant circuit 33c is electrically connected between the third inverter circuit 32c and the primary winding of the third transformer T₃. The first LLC resonant circuit 33a, the second LLC resonant circuit 33b and the third LLC resonant circuit 33c are configured to perform the resonance. The primary winding of the first transformer T₁, the primary winding of the second transformer T₂ and the primary winding of the third transformer T₃ are electrically connected to the first inverter circuit 32a, the second inverter circuit 32b and the third inverter circuit 32c respectively, and are configured to transfer the electric energy of the high frequency AC voltage from the primary winding to the secondary winding. The first output rectifier circuit 34a, the second output rectifier circuit 34b and the third output rectifier circuit 34c are electrically connected to the secondary winding of the first transformer T₁, the secondary winding of the second transformer T₂ and the secondary winding of the third transformer T₃, respectively, and are configured to convert the high frequency AC voltage into the DC voltage with desired voltage level.

In some embodiments, the first input rectifier circuit 30a, the second input rectifier circuit 30b and the third input rectifier circuit 30c include a plurality of switches to form a full-bridge circuit or a half-bridge circuit respectively, but not limited thereto. The first input filter circuit 31a, the second input filter circuit 31b, and the third input filter circuit 31c include an input filter capacitor C₁, an input filter capacitor C₂, and an input filter capacitor C₃, respectively. The first inverter circuit 32a, the second inverter circuit 32b and the third inverter circuit 32c include a plurality of switches to form a full-bridge circuit or a half-bridge circuit respectively, but not limited thereto. Each of the first LLC resonant circuit 33a, the second LLC resonant circuit 33b and the third LLC resonant circuit 33c includes a resonant capacitor, a resonant inductor and a magnetizing inductor.

In some embodiments, the first output rectifier circuit 34a includes a first switch circuit and a second switch circuit. The second output rectifier circuit 34b includes a third switch circuit and a fourth switch circuit. The third output rectifier circuit 34c includes a fifth switch circuit and a sixth switch circuit. The first switch circuit includes a first switch S₁ and a second switch S₂. The second switch circuit includes a third switch S₃ and a fourth switch S₄. The third switch circuit includes a fifth switch S₅ and a sixth switch S₆. The fourth switch circuit includes a seventh switch S₇ and an eighth switch S₈. The fifth switch circuit includes a ninth switch S₉ and a tenth switch S₁₀. The sixth switch circuit includes an eleventh switch S₁₁ and a twelfth switch S₁₂. A first terminal of the first switch S₁ is electrically connected to the positive output terminal of the three-phase single-stage power supply 3, a first terminal of the fifth switch S₅ and a first terminal of the ninth switch S₉. A second terminal of the first switch S₁ is electrically connected to a first terminal of the second switch S₂. A second terminal of the second switch S₂ is electrically connected to a second terminal of the sixth switch S₆ and a second terminal of the tenth switch S₁₀. A first terminal of the third switch S₃ is electrically connected to a first terminal of the seventh switch S₇ and a first terminal of the eleventh switch S₁. A second terminal of the third switch S₃ is electrically connected to a first terminal of the fourth switch S₄. A second terminal of the fourth switch S₄ is electrically connected to a second terminal of the eighth switch S₈, a second terminal of the twelfth switch S₁₂ and the negative output terminal of the three-phase single-stage power supply 3. A second terminal of the fifth switch S₅ is electrically connected to a first terminal of the sixth switch S₆. A second terminal of the seventh switch S₇ is electrically connected to a first terminal of the eighth switch S₈. A second terminal of the ninth switch S₉ is electrically connected to a first terminal of the tenth switch S₁₀. A second terminal of the eleventh switch S₁₁ is electrically connected to a first terminal of the twelfth switch S₁₂.

In some embodiments, the first single-stage conversion module 3a further includes a first output capacitor Cₒ₁ and a second output capacitor Cₒ₂. The second single-stage conversion module 3b further includes a third output capacitor Cₒ₃ and a fourth output capacitor Cₒ₄. The third single-stage conversion module 3c further includes a fifth output capacitor Cₒ₅ and a sixth output capacitor Cₒ₆. The first output capacitor Cₒ₁ is electrically connected between the first terminal of the first switch S₁ and the second terminal of the second switch S₂, and the second output capacitor Cₒ₂ is electrically connected between the first terminal of the third switch S₃ and the second terminal of the fourth switch S₄. The third output capacitor Cₒ₃ is electrically connected between the first terminal of the fifth switch S₅ and the second terminal of the sixth switch S₆. The fourth output capacitor Cₒ₄ is electrically connected between the first terminal of the seventh switch S₇ and the second terminal of the eighth switch S₈. The fifth output capacitor Cos is electrically connected between the first terminal of the ninth switch S₉ and the second terminal of the tenth switch S₁₀. The sixth output capacitor Coo is electrically connected between the first terminal of the eleventh switch S₁ and the second terminal of the twelfth switch S₁₂.

In some embodiments, the third single-stage conversion module 3c of the three-phase single-stage power supply 3 further includes a first relay R₁ₐ, an auxiliary inductor Lₐ and an auxiliary capacitor Cₐ. The first relay R₁ₐ, the auxiliary inductor Lₐ and the auxiliary capacitor Cₐ are connected in series to form a series branch. A first end of the series branch is electrically connected to the second terminal of the eleventh switch S₁₁ and the first terminal of the twelfth switch S₁₂. A second end of the series branch is electrically connected to the negative output terminal of the three-phase single-stage power supply 3. Through the settings of the first relay R₁ₐ, the auxiliary inductor Lₐ, the auxiliary capacitor Cₐ, the eleventh switch S₁₁ and the twelfth switch S₁₂ in the third single-stage conversion module 3c, a buck/boost converter is formed. When the three-phase single-stage power supply 3 receives a single-phase input voltage to operate, the buck/boost converter can compensate for the low-frequency output voltage/output current ripple. To further explain, when the three-phase single-stage power supply 3 receives a single-phase input voltage or receives an unbalanced three-phase input voltage to operate, all switches on the primary side of the third transformer T₃ in the third single-stage conversion module 3c and the ninth switch S₉ and the tenth switch S₁₀ on the secondary side of the third transformer T₃ are both disabled.

In some embodiments, the three-phase single-stage power supply 3 further includes an input relay R₂ₐ electrically connected between the input terminal of the first single-stage conversion module 3a and the input terminal of the second single-stage conversion module 3b. This input relay R₂ₐ helps to configure the AC input of three-phase single-stage power supply 3 from three phase to single phase. When the three-phase single-stage power supply 3 only receives single-phase AC input, for example, at the input of first single-stage conversion module 3a, the input relay R₂ₐ is turned on to supply the second single-stage conversion module 3b with the same single-phase AC input voltage as the first single-stage conversion module 3a. This way the first single-stage conversion module 3a and the second single-stage conversion module 3b operate with the same single-phase AC input voltage and perform AC-DC power conversion with the variable switching frequency and delay-time control as described in the prior art. When the AC input of the three-phase single-stage power supply 3 is operated with an unbalanced three-phase input voltage, the first single-stage conversion module 3a, the second single-stage conversion module 3b and the third single-stage conversion module 3c utilize variable switching frequency and delay-time control to perform power factor correction, and the relay R₂ₐ is turned off.

FIG. 3B is a control block diagram of the third single-stage conversion module in the three-phase single-stage power supply of FIG. 3A. The third single-stage conversion module 3c includes a control unit 3d. The control unit 3d includes an adder-subtractor 35c and is configured to compare the sensed output voltage V_{dc} or the output current I_{dc} of the three-phase single-stage power supply 3 with the output voltage reference value V_{ref} or the output current reference value I_{ref} and generate a comparison result. The control unit 3d further includes a proportional-integral (PI) controller 36c connected to the adder-subtractor 35c. The proportional-integral (PI) controller 36c processes the comparison result to generate the duty cycle signal V_{duty}. The control unit 3d further includes a comparator 37c connected to the output of proportional-integral (PI) controller 36c. The comparator 37c is configured to compare the duty cycle signal V_{duty} with the fixed frequency pulse width modulation signal ramp Rₐₘₚ to generate switching signals for the eleventh switch S₁₁ and the twelfth switch S₁₂. The control unit 3d further includes an inverter 38c connected to the comparator 37c. The comparator 37c transmits the switching signal to the twelfth switch S₁₂ through the inverter 38c, so the operating states of the eleventh switch S₁₁ and the twelfth switch S₁₂ are opposite. With the duty cycle control of the eleventh switch S₁₁ and the twelfth switch S₁₂, the power transmission between the auxiliary capacitor Cₐ and the equivalent output capacitor formed by the parallel connection of the first to the sixth output capacitors Cₒ₁, Cₒ₂, Cₒ₃, Cₒ₄, Cₒ₅, and Cₒ₅ is controlled to reduce the low-frequency ripple of output current Ide/output voltage V_{dc}.

In some embodiments, the third single-stage conversion module 3c further includes a DC blocking capacitor C₃ₐ. A first terminal of the DC blocking capacitor C₃ₐ is electrically connected to a secondary winding Nₛ₃ of the third transformer T₃. A second terminal of the DC blocking capacitor C₃ₐ is electrically connected to the second terminal of the ninth switch S₉ and the first terminal of the tenth switch S₁₀ in the fifth switch circuit. In addition, the third LLC resonant circuit 33c further includes a resonant capacitor C_{3b} electrically connected between the third inverter circuit 32c and a primary winding Nₚ₃ of the third transformer T₃.

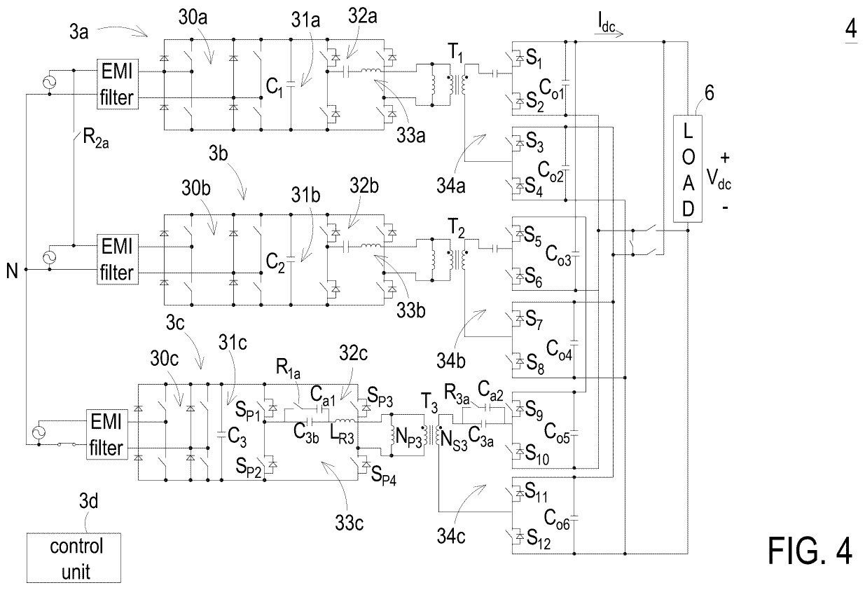

FIG. 4 is a schematic circuit diagram illustrating a three-phase single-stage power supply according to a second embodiment of the present disclosure. In the second embodiment, the circuit topology of the three-phase single-stage power supply 4 is similar to that of the three-phase single-stage power supply 3 of FIG. 3A, wherein elements with same structures and functions are denoted with same symbols, and are not redundantly described herein. Compared with the three-phase single-stage power supply 3 shown in FIG. 3A having the third single-stage conversion module 3c with the first relay R₁ₐ, the auxiliary inductor Lₐ and the auxiliary capacitor Cₐ, the third single-stage conversion module 3c of the three-phase single-stage power supply 4 is changed to include a first relay R₁ₐ, a first auxiliary capacitor Cₐ₁, a second relay R₃ₐ and a second auxiliary capacitor Cₐ₂. The first relay R₁ₐ is electrically connected in series with the first auxiliary capacitor Cₐ₁ and then connected in parallel with the resonant capacitor C_{3b}. The second relay R₃ₐ is electrically connected in series with the second auxiliary capacitor Cₐ₂ and then connected in parallel with the DC blocking capacitor C₃ₐ. In addition, a capacitance value of the first auxiliary capacitor Cₐ₁ is much greater than a capacitance value of the resonant capacitor C_{3b}.

When the three-phase single-stage power supply 4 receives a single-phase input voltage to operate, the input relay R₂a, the first relay R₁ₐ and the second relay R₃ₐ are enabled and turned on. Since the capacitance value of the first auxiliary capacitor Cₐ₁ is much greater than the capacitance value of the resonant capacitor C_{3b}, the first equivalent capacitance formed by the parallel connection of the first auxiliary capacitor Cₐ₁ and the resonant capacitor C_{3b} is approximately equal to the first auxiliary capacitor Cₐ₁. In addition, since the first equivalent capacitance formed by the parallel connection of the first auxiliary capacitor Cₐ₁ and the resonant capacitor C_{3b} has a larger capacitance value, compared with the impedance of the resonant inductor L_{R3} connected in series with the resonant capacitor C_{3b} in the third LLC resonant circuit 33c, the impedance of the first equivalent capacitor is small and therefore, the effect of the first equivalent capacitor on the operation of the circuit is negligible. In addition, the second auxiliary capacitor Cₐ₂ and the DC blocking capacitor C₃ₐ are electrically connected in parallel to form a second equivalent capacitance. Due to the settings of the second equivalent capacitance, the ninth switch S₉, the tenth switch S₁₀ and the resonant inductor L_{R3}, the third single-stage conversion module 3c can form a buck/boost converter. When the three-phase single-stage power supply 4 receives a single-phase input voltage to operate, the buck/boost converter can compensate the low-frequency output voltage V_{dc}/output current I_{dc} ripple generated at the output terminal of the three-phase single-stage power supply 4.

In some embodiments, the third inverter circuit 32c includes a first primary switch Sₚ₁, a second primary switch Sₚ₂, a third primary switch Sₚ₃ and a fourth primary switch Sₚ₄. The first primary switch Sₚ₁ and the second primary switch Sₚ₂ are electrically connected in series to form the first bridge arm. The third primary switch Sₚ₃ and the fourth primary switch Sₚ₄ are electrically connected in series to form the second bridge arm.

In addition, during the buck/boost operation of the third single-stage conversion module 3c, the second primary switch Sₚ₂ and the fourth primary switch Sₚ₄ of the third inverter circuit 32c and the twelfth switch S₁₂ are permanently turned on, and all switches in the third input rectifier circuit 30c, the first primary switch Sₚ₁, the third primary switch Sₚ₃ and the eleventh switch S₁₁ are permanently turned off. In addition, the control principle of the third single-stage conversion module 3c of the three-phase single-stage power supply 4 in the second embodiment is similar to the control principle shown in FIG. 3B, and is not redundantly described herein.

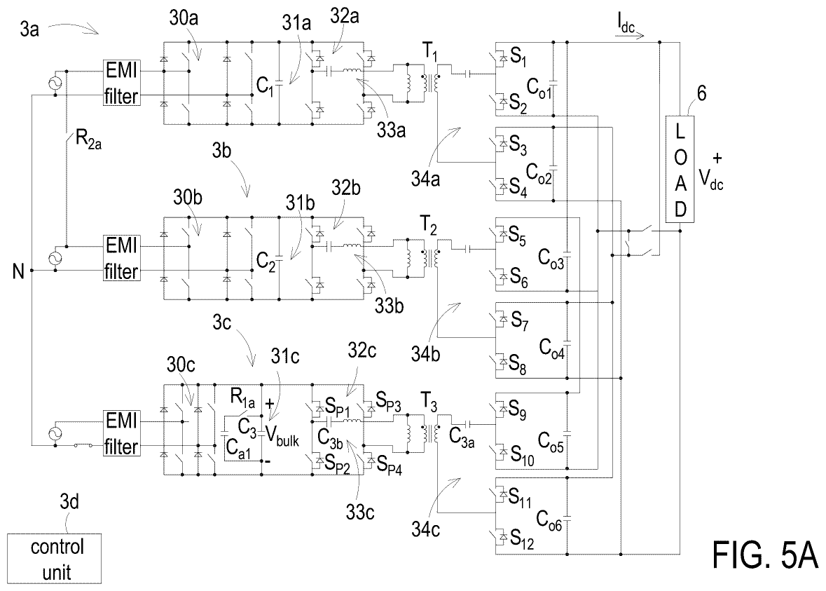

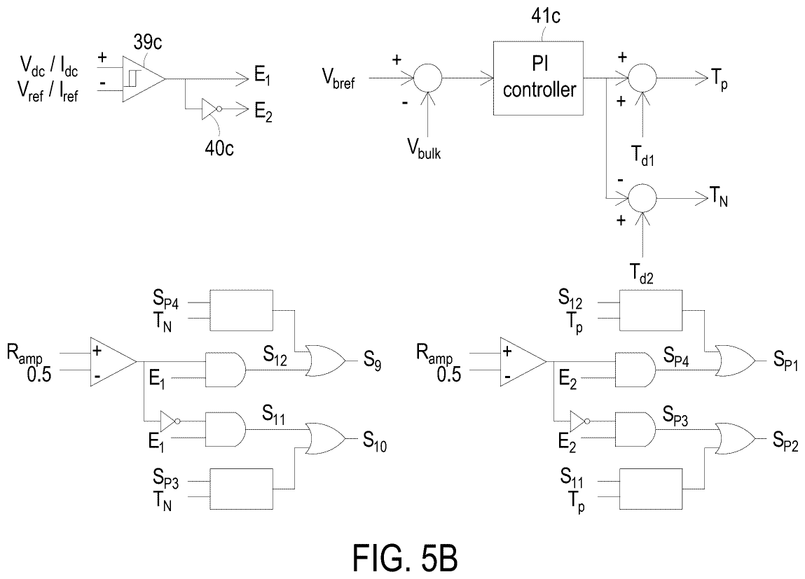

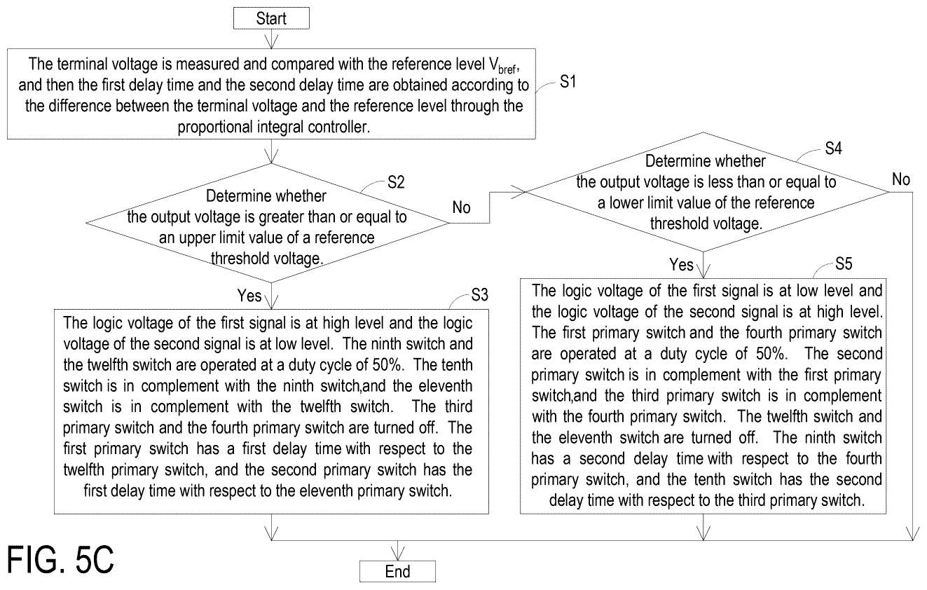

FIG. 5A is a schematic circuit diagram illustrating a three-phase single-stage power supply according to a third embodiment of the present disclosure. In the third embodiment, the circuit topology of the three-phase single-stage power supply 5 is similar to that of the three-phase single-stage power supply 3 of FIG. 3A, wherein elements with same structures and functions are denoted with same symbols, and are not redundantly described herein. Compared with the three-phase single-stage power supply 3 shown in FIG. 3A having the third single-stage conversion module 3c with the first relay Ria, the auxiliary inductor Lₐ and the auxiliary capacitor Cₐ, the third single-stage conversion module 3c of the three-phase single-stage power supply 5 is changed to include a first relay R₁ₐ and a first auxiliary capacitor Cₐ₁. The first relay R₁ₐ and the first auxiliary capacitor Cₐ₁ are electrically connected in series and then connected in parallel with the third input filter circuit 31c.

In the embodiment, the compensation for the low-frequency output voltage/output current ripple generated at the output terminal of the three-phase single-stage power supply 5 is achieved by the operation of the third LLC resonant circuit 33c. The electric energy is transferred from the first output capacitor Cₒ₁, the second output capacitor Cₒ₂, the third output capacitor Cₒ₃, the fourth output capacitor Cₒ₄, the fifth output capacitor Cₒ₅ and the sixth output capacitor Cₒ₆ to an equivalent input capacitance formed by the parallel connection of the first auxiliary capacitor Cₐ₁ and the input filter capacitor C₃ of the third input filter circuit 31c, or the electric energy is transferred from the above equivalent capacitance to the first output capacitor Cₒ₁, the second output capacitor Cₒ₂, the third output capacitor Cₒ₃, the fourth output capacitor Cₒ₄, the fifth output capacitor Cₒ₅ and the sixth output capacitor Cₒ₆. It should be noted that a capacitance value of the first auxiliary capacitor Cₐ₁ is much greater than a capacitance value of the input filter capacitor C₃ of the third input filter circuit 31c, so as to store the electric energy transferred by the equivalent output capacitor formed by parallel connection of the first to sixth output capacitors Cₒ₁, Cₒ₂, Cₒ₃, Cₒ₄, Cₒ₅ and Cₒ₆ when the third single-stage conversion module 3c is used for ripple compensation.

FIG. 5B is a control block diagram of the third single-stage conversion module in the three-phase single-stage power supply of FIG. 5A. When the output voltage Vac or the output current I_{dc} of the three-phase single-stage power supply 5 is greater than the output voltage reference value V_{ref} or the output current reference value I_{ref}, the comparator 39c of the control unit of the third single-stage conversion module 3c outputs a first signal E₁ at high level. The first signal E₁ also passes through the inverter 40c and outputs a second signal E₂ at zero level. When the first signal E₁ is at a high level, the power must be transferred from the equivalent output capacitor to the equivalent input capacitance. Therefore, the eleventh switch S₁₁ and the twelfth switch S₁₂ are operated with 50% duty-cycle switching pulse generated by comparing a triangular ramp signal with a DC level of 0.5. Since the second signal E₂ is at zero level, the third primary switch Sₚ₃ and the fourth primary switch Sₚ₄ of the third inverter circuit 32c are also at zero level. That is, these switches have been disabled during the operation. Since the third primary switch Sₚ₃ and the fourth primary switch Sₚ₄ are at zero level, the ninth switch S₉ and the tenth switch S₁₀ have the same switching pulses as the eleventh switch S₁₁ and the twelfth switch S₁₂, respectively, due to the OR gate operation. The first primary switch Sₚ₁ and the second primary switch Sₚ₂ of the third inverter circuit 32c are operated with a first delay time T_{P} with respect to the twelfth switch S₁₂ and the eleventh switch Sul, respectively. When the third single-stage conversion module 3c operates at a constant switching frequency, the first delay time T_{P} controls the amount of power transferred between the equivalent output capacitor to the equivalent input capacitor.

Similarly, when the output voltage V_{dc} or the output current I_{dc} is smaller than or equal to the output voltage reference value V_{ref} or the output current reference value I_{ref}, the second signal E₂ is at a high level and the first signal E₁ is at a zero level. When the second signal E₂ is at a high level, the power must be transferred from the equivalent input capacitor to the equivalent output capacitor. Therefore, the third primary switch Sₚ₃ and the fourth primary switch Sₚ₄ are operated with 50% duty-cycle switching pulses generated by comparing a triangular ramp signal with a DC level of 0.5. Since the first signal E₁ is at zero level, the eleventh switch S₁₁ and the twelfth switch S₁₂ are also at zero level, i.e., these switches are disabled during operation. Since the eleventh switch S₁₁ and the twelfth switch S₁₂ are at zero level, therefore, the first primary switch Sₚ₁ and the second primary switch Sₚ₂ have the same switching pulses as the fourth primary switch Sₚ₄ and the third primary switch Sₚ₃, respectively, due to the OR gate operation. The ninth switch S₉ and the tenth switch S₁₀ are operated with a second time delay Tx with respect to the fourth primary switch Sₚ₄ and the third primary switch Sₚ₃, respectively. The second time delay T_{N} controls the amount of power transferred from the equivalent input capacitor to the equivalent output capacitor while the third single-stage conversion module 3c operates at a constant switching frequency.

In addition, the power transferred from the equivalent output capacitor to the equivalent input capacitor (depending on the first delay time T_{P}) may not be equal to the amount of the power transferred from the equivalent input capacitor to the equivalent output capacitor (depending on the second delay time T_{N}). This mismatch in the power transferred to the equivalent input capacitor and the power transferred out from the equivalent input capacitor will result in a large deviation in the terminal voltage V_{bulk} across the input filter capacitor C₃.

In order to maintain the terminal voltage V_{bulk} across two terminals of the input filter capacitor C₃ at the reference level V_{bref}, the terminal voltage V_{bulk} must be measured and compared with the reference level V_{bref}. Then, the difference between the terminal voltage V_{bulk} and the reference level V_{bref} is controlled through the proportional integral controller 41c. The proportional integral controller 41c controls the first delay time T_{P} and the second delay time T_{N} at the first preset value T_{d1} and the second preset value T_{d2}, respectively. If the terminal voltage V_{bulk}>the reference level V_{bref}, their difference will be negative, which will result in the proportional integral controller 41c to output a negative value, so that the first delay time T_{P} will decrease and the second delay time T_{N} will increase. Therefore, the power transferred from the equivalent input capacitor will increase as compared to the power transferred from the equivalent output capacitor to the equivalent input capacitor. This will reduce the terminal voltage V_{bulk}. If the terminal voltage V_{bulk}<reference level V_{bref}, a similar operation can be explained. That is, the first delay time T_{P} will increase, and the second delay time T_{N} will decrease. Furthermore, as shown in FIG. 5B, there is a hysteresis between the operation when the power is transferred from the equivalent output capacitor to the equivalent input capacitor, i.e., when the first signal E₁ is at high level, and when the power is transferred from the equivalent input capacitor to the equivalent output capacitor, i.e., when the second signal E₂ is at high level. The above-mentioned control method is also applicable to the embodiments as shown in FIG. 3A and FIG. 4.

Please refer to FIG. 5C, which is a schematic diagram illustrating the steps of the control method of the third single-stage conversion module of the three-phase single-stage power supply shown in FIG. 5A. First, in step S₁, the terminal voltage V_{bulk} is measured and compared with the reference level V_{bref}. Then, the first delay time T_{P} and the second delay time T_{N} are obtained according to the difference between the terminal voltage V_{bulk} and the reference level V_{bref} through the proportional integral controller 41c. In step S2, it is determined whether the output voltage V_{dc} is greater than or equal to an upper limit value of a reference threshold voltage. In step S3, when the determining result of the step S2 is satisfied, the logic voltage of the first signal Er is at high level and the logic voltage of the second signal E₂ is at low level. The ninth switch S₉ and the twelfth switch S₁₂ are operated at a duty cycle of 50%. The ninth switch S₉ and the tenth switch S₁₀ are complementary to each other, and the eleventh switch S₁₁ and the twelfth switch S₁₂ are complementary to each other. The third primary switch Sₚ₃ and the fourth primary switch Sₚ₄ are turned off. The first primary switch Sₚ₁ has a first delay time T_{P} with respect to the twelfth switch S₁₂, and the second primary switch Sₚ₂ has a first delay time T_{P} with respect to the eleventh switch S₁₁. In step S4, when the determining result of the step S2 is not satisfied, it is determined whether the output voltage Vac is less than or equal to a lower limit value of the reference threshold voltage. In step S5, when the determining result of the step S4 is satisfied, the logic voltage of the first signal Er is at low level and the logic voltage of the second signal E₂ is at high level. The first primary switch Sₚ₁ and the fourth primary switch Sₚ₄ are operated at a duty cycle of 50%. The first primary switch Sₚ₁ and the second primary switch Sₚ₂ are complementary to each other, and the third primary switch Sₚ₃ and the fourth primary switch Sₚ₄ are complementary to each other. The twelfth switch S₁₂ and the eleventh switch S₁₁ are turned off. The ninth switch S₉ has a second delay time T_{N} with respect to the fourth primary switch Sₚ₄, and the tenth switch S₁₀ has a second delay time T_{N} with respect to the third primary switch Sₚ₃. When the determining result of the step S4 is not satisfied, the control ends.

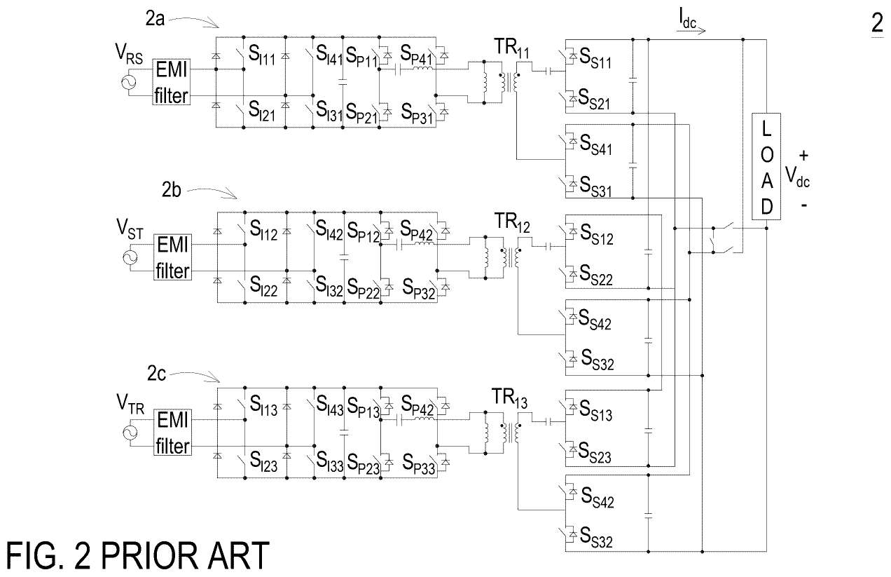

In addition, as mentioned above, the ripple of the low-frequency output voltage/output current can become relatively large when the three-phase single-stage power supply 2 shown in FIG. 2 is operated with the single-phase input voltage or the unbalanced three-phase input voltage. With a balanced three-phase input voltage source, each single-stage conversion module operates with voltages which are equal in magnitude and two consecutive phases have a phase shift of 120 degrees between them. When the three-phase single-stage power supply 2 operates with the balanced three-phase input voltage, each single-stage conversion module carries one-third of the total output power, and the output voltage/output current ripples of the three single-stage conversion modules are exactly phase-shifted by 120 degrees. In this way, the three-output voltage/output current ripples of the three single-stage conversion modules cancel each other, and the resulting low-frequency output voltage/output current ripple is relatively small. However, with an unbalanced three-phase input voltage, even if each single-stage conversion module carries equal power, the three output voltage/output current ripples of the three single-stage conversion modules may not be exactly phase-shifted by 120 degrees, which results in a large output voltage and output current ripple. In order to reduce the low-frequency output voltage/current ripple, the input admittance of each phase is adjusted individually with a feedback loop.

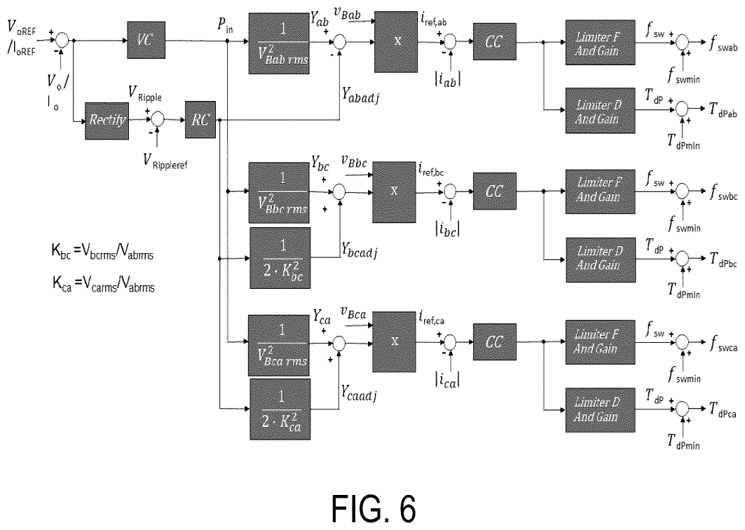

FIG. 6 is a partial control block diagram of the third single-stage conversion module of the three-phase single-stage power supply shown in FIG. 2 when the three-phase single-stage power supply is operated with an unbalanced three-phase input voltage. The three-phase unbalanced input voltages received by the three-phase single-stage power supply 2 are assumed such that ab-phase root mean square V_{abrms}>bc-phase root mean square V_{berms}>ca-phase root mean square V_{carms}. In this embodiment, the ripple of the output voltage/output current needs to be compensated and a ripple compensation module is added, which adds or subtracts the adjustments Y_{abadj}, Y_{bcadj}, Y_{caadj} to the input admittances Y_{ab}, Y_{bc}, Y_{ca}, respectively. The adjustments Y_{abadj}, Y_{bcadj}, Y_{caadj} are proportional to the output of the voltage controller VC. In the ripple compensation module, the difference of the output voltage/current reference and the measured output voltage/current is rectified to obtain a ripple comparison value V_{Ripple}. The ripple comparison value V_{Ripple} is compared with a reference value V_{Rippleref} which is passed through a ripple compensator RC. The output of the ripple compensator RC is subtracted from the input admittance of the phase which has the largest root mean square value of the input voltage among the three phases, in this example, ab-phase. The output of the ripple compensator RC is multiplied with constants ½·K_{bc}² and ½·K_{bc}² and added to the input admittances of other two phases, in this example, bc-phase and ca-phase, respectively, where K_{bc}=(bc-phase root mean square V_{berms})/(ab-phase root mean square V_{abrms}) and K_{ca}=(ca-phase root mean square V_{carms})/(ab-phase root mean square V_{abrms}). The input admittances of the three-phases are adjusted in such a way that the total input power Pin of the three phases remains the same compared to that without the adjustments. The total input power with adjustments in input admittances is obtained as shown in the following equation (1):

$${P}_{i n} = {V}_{a b r m s}^{2} \cdot ( {Y}_{a b} + {Y}_{a b a d j} ) + {V}_{b c r m s}^{2} \cdot ( {Y}_{b c} + {Y}_{b c a d j} ) + {V}_{c a r m s}^{2} \cdot ( {Y}_{c a} + {Y}_{c a a d j} ) \qquad ( 1 )$$

For the total input power Pin to be the same as that without the adjustments in the input admittances, the following equation (2) is used to calculate:

$${V}_{abrms}^{2} \cdot {Y}_{abadj} + {V}_{bcrms}^{2} \cdot {Y}_{bcadj} + {V}_{carms}^{2} \cdot {Y}_{caadj} = 0 \qquad ( 2 )$$

Substituting V_{berms}=K_{bc}*V_{abrms} and V_{carms}=K_{ca}*V_{abrms} in (2), the following equation (3) is

$$satisfied if {Y}_{b c a d j} = - {Y}_{a b a d j} / 2 \cdot {K}_{b c}^{2} and {Y}_{c a a d j} = - {Y}_{a b a d j} / 2 \cdot {K}_{c a}^{2} \qquad ( 3 )$$

$${Y}_{abadj} + {K}_{b c}^{2} \cdot {Y}_{bcadj} + {K}_{c a}^{2} \cdot {Y}_{caadj} = 0$$

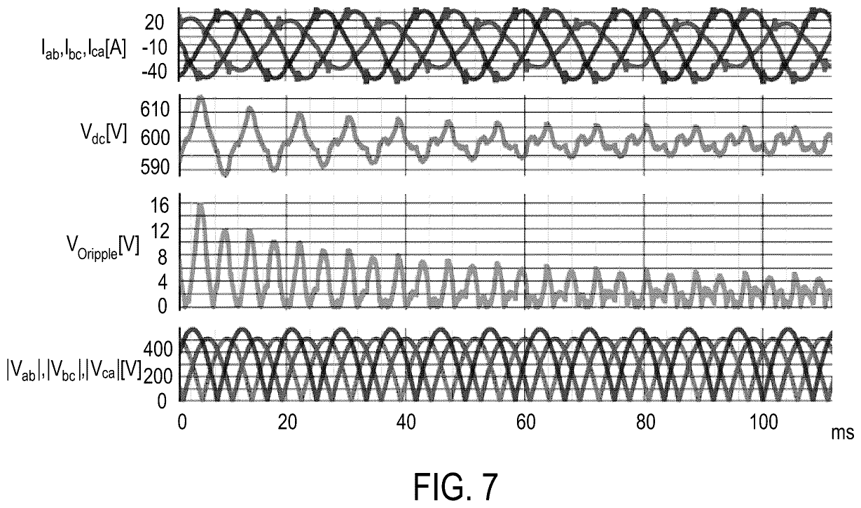

FIG. 7 is a key simulation waveform illustrating the three-phase single-stage power supply shown in FIG. 2. For the three-phase single-stage power supply operating with the three-phase unbalanced input voltage, the initial value of the output voltage ripple V_{Oripple} outputted by the three-phase single-stage power supply is very large, but the output voltage ripple V_{Oripple} can be gradually decreased through the ripple compensator RC by adjusting the input admittance of each single phase in the three-phase system. In FIG. 7, lab, Ibe and Ica are the input currents of the first single-stage conversion module, the second single-stage conversion module and the third single-stage conversion module in the three-phase single-stage power supply, respectively, and V_{ab}, V_{bc} and V_{ca} are the input voltages of the first single-stage conversion module, the second single-stage conversion module and the third single-stage conversion module in the three-phase single-stage power supply, respectively.

It should be noted that the embodiments mentioned in the present disclosure can be applied to different circuit topologies of any three-phase single-stage power supply.

This present disclosure describes different embodiments and their control for compensating output voltage and current ripple of a three-phase single-stage AC/DC converter when it operates with either single-phase AC input voltage or an unbalanced three-phase AC input voltages. In the present disclosure, the three-phase single-stage AC/DC converter is based on LLC resonant converter. However, same ripple cancellation techniques can be applied to any single-stage AC/DC converters based on dual active bridge (DAB), CLLC, CLLLC, LCL-T or series resonant converter.

In summary, the present disclosure provides a three-phase single-stage power supply. One of the single-stage conversion modules of the three-phase single-stage power supply includes at least one relay and at least one auxiliary capacitor, so that the cooperation of the at least one relay and at least one auxiliary capacitor along with the proposed control is used to reduce the ripple of the low-frequency output voltage/output current when the three-phase single-stage power supply operates with a single-phase input voltage or an unbalanced three-phase input voltage.

Although explanatory embodiments have been described, other embodiments are possible. Therefore, the spirit and scope of the claims should not be limited to the description of the exemplary embodiments.

What is claimed is:

1. A three-phase single-stage power supply, comprising:
a positive output terminal;
a negative output terminal;
a first single-stage conversion module;
a second single-stage conversion module; and
a third single-stage conversion module;
wherein an output terminal of the first single-stage conversion module, an output terminal of the second single-stage conversion module and an output terminal of the third single-stage conversion module are electrically connected in parallel between the positive output terminal and the negative output terminal, wherein the third single-stage conversion module comprises a third transformer, a third output rectifier circuit, a relay, an auxiliary inductor and an auxiliary capacitor, wherein the third output rectifier circuit includes a fifth switch circuit and a sixth switch circuit, the fifth switch circuit and the sixth switch circuit comprise two switches connected in series, respectively, and the relay, the auxiliary inductor and the auxiliary capacitor are connected in series between a midpoint of the two switches of the sixth switch circuit and the negative output terminal, so that the third single-stage conversion module is served as a buck/boost converter.

2. The three-phase single-stage power supply according to claim 1, wherein when the three-phase single-stage power supply receives a single-phase input voltage, all switches on a primary side of the third transformer and the two switches in the fifth switch circuit of the third single-stage conversion module are disabled.

3. The three-phase single-stage power supply according to claim 1, further comprising an input relay electrically connected between an input terminal of the first single-stage conversion module and an input terminal of the second single-stage conversion module.

4. The three-phase single-stage power supply according to claim 1, further comprising a control unit, wherein the control unit comprises:
an adder-subtractor configured to compare a sensed output voltage or a sensed output current of the three-phase single-stage power supply with an output voltage reference value or an output current reference value and generate a comparison result;
a proportional-integral controller connected to the adder-subtractor and configured to generate a duty cycle signal by processing the comparison result;
a comparator connected to an output of the proportional-integral controller and configured to compare the duty cycle signal with a fixed frequency pulse width modulation signal to generate switching signals for the two switches of the sixth switch circuit; and
an inverter connected to the comparator;
wherein the comparator transmits the switching signal to the one of the two switches of the sixth switch circuit through the inverter, so the operating states of the two switches of the sixth switch circuit are opposite.

5. The three-phase single-stage power supply according to claim 4, wherein the first single-stage conversion module, the second single-stage conversion module and the third single-stage conversion module comprise an input admittance respectively, and the three-phase single-stage power supply comprises a ripple compensation module, wherein when the three-phase single-stage power supply is operated with an unbalanced three-phase input voltage, a difference of the output voltage and an output voltage reference value or a difference of the output current and an output current reference value is rectified by the ripple compensation module to obtain a ripple comparison value, wherein the ripple compensation module compares the ripple comparison value with a ripple reference value and adjusts the respective input admittance of the first single-stage conversion module, the second single-stage conversion module and the third single-stage conversion module according to the comparing result of the ripple comparison value and the ripple reference value so as to reduce ripple of the output voltage and the output current.

6. A three-phase single-stage power supply, comprising:
a positive output terminal;
a negative output terminal;
a first single-stage conversion module;
a second single-stage conversion module; and
a third single-stage conversion module;
wherein an output terminal of the first single-stage conversion module, an output terminal of the second single-stage conversion module and an output terminal of the third single-stage conversion module are electrically connected in parallel between the positive output terminal and the negative output terminal, wherein the third single-stage conversion module comprises an input rectifier circuit, a third inverter circuit, a third LLC resonant circuit, a DC blocking capacitor, a resonant capacitor, a third transformer, a third output rectifier circuit, a first relay, a first auxiliary capacitor, a second relay and a second auxiliary capacitor, wherein the third output rectifier circuit includes a fifth switch circuit and a sixth switch circuit, the fifth switch circuit and the sixth switch circuit comprise two switches connected in series, respectively, the DC blocking capacitor is electrically connected between a secondary winding of the third transformer and a midpoint of the two switches of the fifth switch circuit, a resonant capacitor of the third LLC resonant circuit is electrically connected between the third inverter circuit and a primary winding of the third transformer, the first relay is connected in series with the first auxiliary capacitor and then connected in parallel with the resonant capacitor, and the second relay is connected in series with the second auxiliary capacitor and then connected in parallel with the DC blocking capacitor, so that the third single-stage conversion module performs buck/boost converter operation.

7. The three-phase single-stage power supply according to claim 6, wherein a capacitance value of the first auxiliary capacitor is greater than a capacitance value of the resonant capacitor.

8. The three-phase single-stage power supply according to claim 6, wherein when the three-phase single-stage power supply receives a single-phase input voltage or receives an unbalanced three-phase input voltage to operate, the first relay and the second relay are conductive.

9. The three-phase single-stage power supply according to claim 6, wherein the third inverter circuit comprises a first primary switch, a second primary switch, a third primary switch and a fourth primary switch, the first primary switch and the second primary switch are connected in series to form a first bridge arm, and the third primary switch and the fourth primary switch are connected in series to form a second bridge arm, wherein during operation of the third single-stage conversion module forming the buck/boost converter, the second primary switch, the fourth primary switch and a lower switch in the sixth switch circuit are permanently turned on, and all switches in the third input rectifier circuit, the first primary switch, the third primary switch and an upper switch in the sixth switch circuit are permanently turned off.

10. The three-phase single-stage power supply according to claim 6, further comprising an input relay electrically connected between an input terminal of the first single-stage conversion module and an input terminal of the second single-stage conversion module.

11. The three-phase single-stage power supply according to claim 10, further comprising a control unit, wherein the control unit comprises:
an adder-subtractor configured to compare a sensed output voltage or a sensed output current of the three-phase single-stage power supply with an output voltage reference value or an output current reference value and generate a comparison result;
a proportional-integral controller connected to the adder-subtractor and configured to allow the comparison result to be proportionally controlled to generate a duty cycle signal;
a comparator connected to the proportional-integral controller and configured to compare the duty cycle signal with a fixed frequency pulse width modulation signal to generate switching signals for the two switches of the fifth switch circuit; and
an inverter connected to the comparator;
wherein the comparator transmits the switching signal to the one of the two switches of the fifth switch circuit through the inverter, so the operating states of the two switches of the fifth switch circuit are opposite.

12. The three-phase single-stage power supply according to claim 11, wherein the first single-stage conversion module, the second single-stage conversion module and the third single-stage conversion module comprise an input admittance respectively, and the three-phase single-stage power supply comprises a ripple compensation module, wherein when the three-phase single-stage power supply is operated with an unbalanced three-phase input voltage, a difference of the output voltage and an output voltage reference value or a difference of the output current and an output current reference value is rectified by the ripple compensation module to obtain a ripple comparison value, wherein the ripple compensation module compares the ripple comparison value with a ripple reference value and adjusts the respective input admittance of the first single-stage conversion module, the second single-stage conversion module and the third single-stage conversion module according to the comparing result of the ripple comparison value and the ripple reference value so as to reduce ripple of the output voltage and the output current.

13. A three-phase single-stage power supply, comprising:
a positive output terminal;
a negative output terminal;
a first single-stage conversion module;
a second single-stage conversion module; and
a third single-stage conversion module;
wherein an output terminal of the first single-stage conversion module, an output terminal of the second single-stage conversion module and an output terminal of the third single-stage conversion module are connected in parallel between the positive output terminal and the negative output terminal, wherein the third single-stage conversion module comprises an input rectifier circuit, a third input filter circuit, a third LLC resonant circuit, a first relay and an auxiliary capacitor, wherein the first relay and the auxiliary capacitor are connected in series and then connected in parallel with the third input filter circuit.

14. The three-phase single-stage power supply according to claim 13, further comprising an input relay electrically connected between an input terminal of the first single-stage conversion module and an input terminal of the second single-stage conversion module.

15. The three-phase single-stage power supply according to claim 13, wherein the third input filter circuit comprises an input filter capacitor, and a capacitance value of the first auxiliary capacitor is greater than a capacitance value of the input filter capacitor.

16. The three-phase single-stage power supply according to claim 13, wherein the third single-stage conversion module further comprises a third inverter circuit, a third transformer and a third output rectifier circuit, wherein the third output rectifier circuit comprises a fifth switch circuit and a sixth switch circuit, the fifth switch circuit comprises a ninth switch and a tenth switch connected in series, the sixth switch circuit comprises an eleventh switch and a twelfth switch connected in series, wherein a resonant capacitor of the third LLC resonant circuit is electrically connected between the third inverter circuit and a primary winding of the third transformer, wherein the third inverter circuit comprises a first primary switch, a second primary switch, a third primary switch and a fourth primary switch, the first primary switch and the second primary switch are connected in series to form a first bridge arm, and the third primary switch and the fourth primary switch are connected in series to form a second bridge arm.

17. The three-phase single-stage power supply according to claim 16, further comprising a control unit, wherein when an output voltage of the three-phase single-stage power supply is greater than or equal to an upper limit value of a reference threshold voltage, the control unit drives the ninth switch and the twelfth switch to operate at a duty cycle of 50%, wherein the ninth switch and the tenth switch are complementary to each other, the eleventh switch and the twelfth switch are complementary to each other, the third primary switch and the fourth primary switch are turned off, the first primary switch has a first delay time with respect to the twelfth switch, and the second primary switch has the first delay time with respect to the eleventh switch.

18. The three-phase single-stage power supply according to claim 17, wherein when the output voltage is less than or equal to a lower limit value of the reference threshold voltage, the control unit drives the first primary switch and the fourth primary switch to operate at a duty cycle of 50%, wherein the first primary switch and the second primary switch are complementary to each other the third primary switch and the fourth primary switch are complementary to each other, the twelfth switch and the eleventh switch are turned off, the ninth switch has a second delay time with respect to the fourth primary switch, and the tenth switch has the second delay time with respect to the third primary switch.

19. The three-phase single-stage power supply according to claim 18, further comprising a control unit, wherein a terminal voltage of the input filter capacitor is compared with a reference level by the control unit, and the first delay time and the second delay time are controlled at a first preset value and a second preset value according to the comparing result, wherein when the terminal voltage of the input filter capacitor is greater than the reference level, the control unit controls the first delay time to decrease and the second delay time to increase, wherein when the terminal voltage of the input filter capacitor is less than the reference level, the control unit controls the first delay time to increase and the second delay time to decrease.

20. The three-phase single-stage power supply according to claim 13, wherein the first single-stage conversion module, the second single-stage conversion module and the third single-stage conversion module comprise an input admittance respectively, and the three-phase single-stage power supply comprises a ripple compensation module, wherein when the three-phase single-stage power supply is operated with an unbalanced three-phase input voltage, a difference of an output voltage and an output voltage reference value or a difference of an output current and an output current reference value is rectified by the ripple compensation module to obtain a ripple comparison value, wherein the ripple compensation module compares the ripple comparison value with a ripple reference value and adjusts the respective input admittance of the first single-stage conversion module, the second single-stage conversion module and the third single-stage conversion module according to the comparing result of the ripple comparison value and the ripple reference value so as to reduce ripple of the output voltage and the output current.
